(19) United States
(12) Patent Application Publication
(10) Pub. No.: US 2008/0082214 A1
(43) Pub. Date: Apr. 3, 2008

(54) Method for animating a robot

(76) Inventors: Sabrina Haskell, Pittsburgh, PA (US); Andrew Hosmer, Pittsburgh, PA (US); Peter Stepniewicz, Orlando, FL (US); Salim Zayat, San Francisco, CA (US)

Correspondence Address: MEYER UNKOVIC & SCOTT LLP, 1300 OLIVER BUILDING, PITTSBURGH, PA, 15222, US

(21) Appl. No.: 11/906,571

(22) Filed: Oct. 3, 2007

Related U.S. Application Data
(60) Provisional application No. 60/848,966, filed on Oct. 3, 2006.

(51) Int. Cl. G05B 15/02

(52) U.S. Cl. 700/264

(57) ABSTRACT

A method for animating a robotic device utilizes 3D modeling and animation tools and techniques. The method begins with creating a digital three-dimensional model of the robotic device. Using the digital three-dimensional model, one or more digital animations for the robotic device are created. These digital animations are converted into hardware control values used by the robotic device's hardware control system. The converted control values are then sent to the hardware control system for the robotic device.

### CROSS-REFERENCE TO RELATED APPLICATION

This application claims the benefit of U.S. Provisional Patent Application No. 60/848,966, filed on Oct. 3, 2006.

### FIELD OF THE INVENTION

The present invention relates to a method for animating physical robots, robotic components and/or animatronic characters. The invention further relates to a method for digitally animating the movement of robots and/or components of same by modeling the robots and/or components and pre-visualizing such movements.

### BACKGROUND OF THE INVENTION

Currently, the movement patterns of animatronic robotic devices are programmed through the use of intricate control panels. Knobs, sliders, buttons, and other input devices on the control panel are connected to the motors of an animatronic robot. A programmer manipulates the knobs and buttons until a desired motion has been achieved. The programmer repeats the knob turns and button presses required to replicate the desired animatronic device movement while recording the control signals sent to the animatronic robot's motors for achieving that motion. The known method for animating is labor intensive and time consuming. It often requires programmers who have extensive robot animating experience.

Once an animatronic robot movement pattern has been created, it cannot be easily modified. If the programmer desires to change even a small portion of movement, the entire animating method must be repeated.

What is needed is a method for animating robotic devices quickly and intuitively. Any such method should also allow for easy modification of animation movement patterns. The present invention addresses this need for animating the movement of a physical animatronic device. Preferred embodiments of this invention use digital design tools and leverage the power of existing 3D animation software so that computer graphic (or “CG”) animators may quickly, yet intuitively, animate physical robots, robotic components and/or many animatronic devices.

### SUMMARY OF THE INVENTION

An object of the present invention provides a method for animating the movement of physical robots, robotic components and/or animatronic characters, that method being less time consuming and less labor intensive than traditional robot animation techniques.

Another object of the present invention provides a method for animating the movement of robotic and animatronic devices that provides for the pre-visualization of movement using modern software tools.

Another object of the present invention provides a method for animating the movement of robotic and animatronic devices with the tools and techniques for animating 3D computer generated characters.

Specifically, what is disclosed is a method for animating one or more motions of a physical robot, robotic component and/or animatronic character through the use of existing 3D animation software. The method comprises: (a) creating a 3D digital replica of the robot: (b) using that 3D digital replica to create, model and test one or more digital animations for the robot; (c) converting the digital animations to hardware control values; and (d) sending the hardware control values to the robot's control system.

Alternatively, the method further includes: creating a CG rendering of the digitally animated motion.

In another embodiment, the method of this invention further includes: processing the control values generated from the digital animation prior to sending the control values to hardware controllers.

One preferred method for creating and using digital 3D animations hereby includes: rigging a 3D model of the physical robot, robotic component or animatronic character; and creating an animation with the rigged 3D model.

### BRIEF DESCRIPTION OF THE DRAWINGS

FIG. 1 illustrates a flow diagram representing a method for animating a robotic animatronic device.

FIG. 2 illustrates a flow diagram representing a method for creating a digital animation using a 3D digital model.

### DETAILED DESCRIPTION OF PREFERRED EMBODIMENTS

The invention will now be described in detail in relation to a preferred embodiment and implementation thereof which is exemplary in nature and descriptively specific as disclosed. As is customary, it will be understood that no limitation of the scope of the invention is thereby intended. The invention encompasses such alterations and further modifications in the illustrated apparatus, and such further applications of the principles of the invention illustrated herein, as would normally occur to persons skilled in the art to which the invention relates.

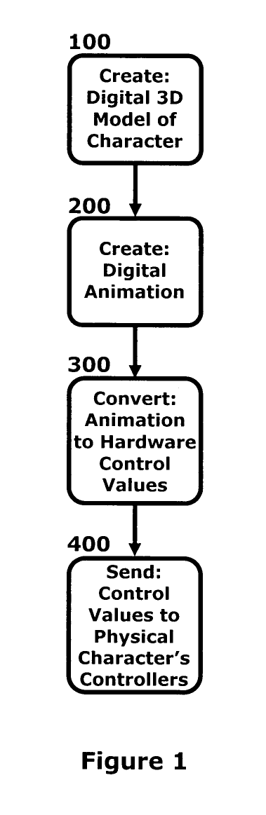

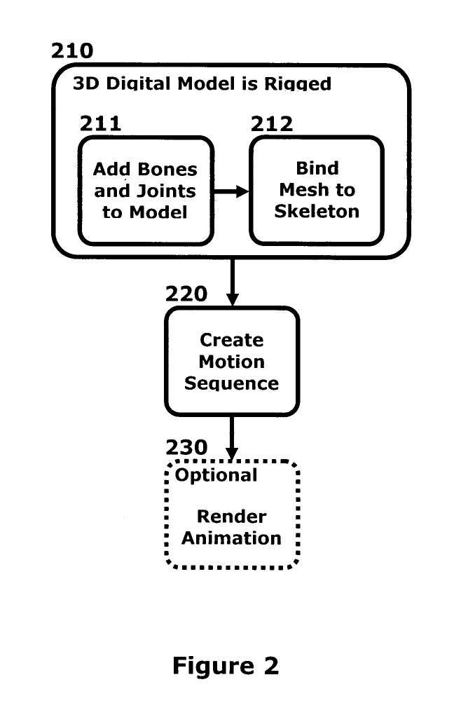

Referring to FIGS. 1 and 2, a method for animating a robotic device is disclosed according to certain preferred embodiments of this invention. The method allows animations created with digital animation software to be “played” directly on physical characters like animatronic creatures, robots or other mechanical devices. The preferred embodiments for animating apply equally to newly designed and created robotic devices, as well as to previously existing (or older) robotic devices which were either never animated or inefficiently animated by the prior, unforgiving rigid animation methods described above.

The animation method of this invention begins by creating a 3D digital model of the robot to be animated. It is understood that many different methods for creating a digital 3D model exist. Any of such methods may be used for step 100 herein. The two most common methods are detailed below:
A 3D model can be created using a computer, keyboard, mouse, computer display, and digital modeling software such as the MAYA® program made and sold by Alias Systems Corp., the 3DS MAX® program made and sold by Autodesk, Inc., the LIGHTWAVE® program made and sold by Newtek, Inc., and the SOLIDWORKS® program made and sold by SolidWorks Corp. There are several known techniques for creating a model using digital software applications like these. Such techniques include, but are not limited to: combining primitives, extruding, lofting, box modeling, facet modeling, constructive solid geometry, parametric based modeling and combinations thereof.
A physical sculpture is created and then imported into a digital modeling software application. If possible, the robotic device itself could be alternatively imported into a digital modeling software application. Several ways for importing 3D digital representations of a physical sculpture into modeling software applications include, but are not limited to: performing a three-dimensional scan of the physical sculpture, or creating a three-dimensional photo model of the physical sculpture.

Once the 3D digital model has been completed, it is used to create a digital animation (200). Such an animation can be created using the previously mentioned, modeling/animating computer software applications like MAYA®, 3DS MAX® and LIGHTWAVE®. Alternate programs to use include the open source BLENDER software, and the RENDERMAN® software programs made and sold by Pixar Corporation.

FIG. 2 provides a flow chart on the steps for creating a 3D character animation (200). Of course, there are many known ways for animating a 3D model, any of which may be used herewith. In one embodiment, the 3D digital model created in step 100 is rigged (210) for preparing that model for animation. Rigging adds a skeleton and controls to the model so that a computer animator can better manipulate and animate the digital model.

Tools in a 3D animation software application can be used to add bones and joints to the digital model (211). The bones and joints of the digital model serve the same function as bones and joints in a human skeleton. These bones and joints are created in such a fashion as to digitally replicate the rigid portions and “joints” of the physical character. The “mesh” (surface) of the model is then bound to the aforementioned skeleton (212).

A computer animation artist uses tools in the 3D animation software to create a motion sequence (step 220). There are several known ways for creating such a motion sequence. Any of them may be used herein. Two of the more common motion sequence creation methods are described below:
For every single frame in a motion sequence, the animation artist uses controls established in the rigging process (step 210) to position the model in a desired pose.
For a certain set of frames (every 10th frame, for example), the computer animation artist uses controls established in the rigging process (step 210) to position the model in a desired pose. These frames are called “keyframes”. The 3D computer animation software then mathematically interpolates between keyframes.

In one preferred embodiment of this invention, the latter “keyframing” method is employed. Most 3D animation software applications allow the motion sequence to be “played back” on the 3D digital model. This allows the animation artist to pre-visualize what the motion sequence will look like when “played” on the robot.

In an optional step, the animation is rendered (230). For every frame in the animation, the 3D computer animation program creates a high quality image of the digital model that incorporates surface textures and lighting. Sets of frames are then grouped together to create an animated visual sequence.

Returning to FIG. 1, the resulting digital animation is converted to hardware control values (300). For every frame in the animation, the rotational position value (in degrees or radians) of each rotational joint in a character's digital model is linearly transformed to a value that specifies the position of a rotational motor. In a preferred embodiment, these values are converted to a number within the range of 0-255 for use with Digital Multiplex or DMX®, a communications protocol typically used to control stage lighting, fog machines, moving lights, and entertainment technologies including many special effect devices. Said protocol can also be used to control robotic servo motors. The linear position value of each linear joint in the digital model is converted to a value for specifying the position of a linear motor. Such position specifying values include, but are not limited to: the electrical signals used as inputs to linear motors, the pulse-width modulation signals used as inputs to linear actuators driven by servo motors, and/or DMX values.

Additionally, the values of other joints or body parts in the digital model that represent electronic devices in a physical character can be converted to values for controlling, i.e. digitally animating, said electronic devices. For instance, color-changing eyes in the physical character may be represented by color changing light-sources in the digital model. The light sources in the digital model may be calibrated such that a value of 1 represents red, a value of 2 represents blue, and so on. These digital light-source values would be converted into values for controlling color changes with that lighting device.

The outputs from these conversions are sets of control values, one set for every frame in the animation. Each set contains a control value for every rotational motor, linear motor, and other electronic devices in the physical character. Optionally, these sets of control values may be processed by a software system. For example, the values may be filtered to remove outlying values, or values above and below certain thresholds. Alternately, values from multiple animations may be combined with various software rules and filters to better blend multiple animations together.

The final sets of control values will be sent to the hardware that controls a physical character's motors and other electronic devices. These control values are sent to hardware controllers at the same frame rate as the digital animation (400). In other words, if the digital animation had a frame rate of 24 frames per second, than the sets of values for each frame in step 600 would be sent to the hardware controller(s) about every 1/24th second. This effectively “plays” a pre-made digital animation on the physical character.

We claim:

1. A method for animating a robotic device, said method comprising the steps of:
a. Creating a digital three-dimensional model of said robotic device;
b. Utilizing the digital three-dimensional model to create a digital animation for at least one component of said robotic device;
c. Converting the created digital animation to hardware control values that can be used by the hardware control system of said robotic device; and
d. Sending the converted hardware control values to the hardware control system of said robotic device.

2. The method of claim 1, wherein said digital model creating step (a) includes: utilizing a computer and a digital modeling software program to create said digital three-dimensional model.

3. The method of claim 1, wherein said digital model creating step (a) comprises:
i. creating a physical sculpture of said robotic device; and
ii. importing a three-dimensional digital representation of said physical sculpture into digital modeling software.

4. The method of claim 3, wherein said importing substep (b)(ii) includes:
performing a three-dimensional scan of said physical sculpture.

5. The method of claim 3, wherein said importing substep (b)(ii) includes:
creating a three-dimensional photo model of said physical sculpture.

6. The method of claim 1, wherein said digital animation creating step (b) includes:
i. Rigging the three-dimensional model; and
ii. Creating a motion sequence for moving at least one component of the rigged three-dimensional model.

7. The method of claim 6, wherein said digital animation creating step (b) further includes:
iii. Creating a computer generated rendering of said motion sequence from substep (ii).

8. The method of claim 6, wherein said rigging substep (i) of said digital animation creating step (b) comprises:
A. Adding bones and joints to make a skeleton for the three dimensional model; and
B. Binding mesh to the skeleton.

9. The method of claim 6, wherein said motion sequence creating substep (b)(ii) includes:
positioning the rigged model in a pose for every animation frame.

10. The method of claim 6, wherein said motion sequence creating substep (b)(ii) includes:
positioning the rigged model in a pose for spaced keyframes.

11. The method of claim 1, wherein said robotic device is a newly designed and fabricated robotic device.

12. The method of claim 1, which is used to animate a pre-existing robotic device.

13. A method for animating a robotic device comprises:
a. Creating a physical sculpture of said robotic device;
b. Importing a three-dimensional digital representation of said physical sculpture into digital modeling software;
c. Utilizing the digital modeling software to create a digital animation for at least one component of said robotic device
d. Converting the created digital animation to hardware control values that can be used by the hardware control system of said robotic device; and
e. Sending the converted hardware control values to the hardware control system of said robotic device.

14. The method of claim 13, wherein said robotic device is a newly designed and fabricated robotic device.

15. The method of claim 13, which is used to animate a pre-existing robotic device.

16. A method for animating a robotic device comprises:
a. Scanning said robotic device into digital modeling software;
b. Utilizing the digital modeling software to create a digital animation for at least one component of said robotic device
c. Converting the created digital animation to hardware control values that can be used by the hardware control system of said robotic device; and
d. Sending the converted hardware control values to the hardware control system of said robotic device.

17. The method of claim 16, wherein said robotic device is a newly designed and fabricated robotic device.

18. The method of claim 16, which is used to animate a pre-existing robotic device.
